(19) United States
(12) Patent Application Publication
(10) Pub. No.: US 2025/0231368 A1
(43) Pub. Date: Jul. 17, 2025

(54) CEMENTED LENS AND MANUFACTURING METHOD OF CEMENTED LENS

(71) Applicant: FUJIFILM Corporation, Tokyo (JP)

(72) Inventor: Kazuki KOMORI, Saitama (JP)

(73) Assignee: FUJIFILM Corporation, Tokyo (JP)

(21) Appl. No.: 19/006,169

(22) Filed: Dec. 30, 2024

(30) Foreign Application Priority Data
Jan. 12, 2024 (JP) 2024-003401

(51) Int. Cl. G02B 7/02; G01M 11/02; G02B 3/04

(52) U.S. Cl. CPC G02B 7/025; G01M 11/0221; G01M 11/0271; G02B 3/04; G02B 7/021

(57) ABSTRACT

A cemented lens in which a first cemented surface that is one lens surface of a first lens and a second cemented surface that is one lens surface of a second lens are cemented to each other by an adhesive, in which the second lens has an aspherical lens surface as the other lens surface, in which an aspherical axis of the aspherical lens surface of the second lens coincides with an optical axis of the first lens and is positionally deviated in a radial direction of the second lens with respect to a center of a paraxial spherical surface of the second cemented surface, and a thickness of the adhesive between the first cemented surface and the second cemented surface varies in a direction of the positional deviation.

### CROSS-REFERENCE TO RELATED APPLICATIONS

This application claims priority from Japanese Patent Application No. 2024-003401, filed on Jan. 12, 2024, the entire disclosure of which is incorporated herein by reference.

### BACKGROUND

### Technical Field

The present disclosure relates to a cemented lens and a manufacturing method of a cemented lens.

### Related Art

JP2017-037155A discloses a cemented lens in which lenses are cemented by an adhesive, in which an adhesive layer between the cemented lenses is thicker on a peripheral side of a range of an effective diameter than a center side of the effective diameter within an optical effective diameter of the lens, and is thinner than a thickest portion outside the effective diameter within the range of the effective diameter.

JP2019-032536 discloses a cemented lens consisting of a lens having a negative power and a lens having a positive power, which comprises a positive power, and a resin adhesive layer that cements the lens having the negative power and the lens having the positive power. In the cemented lens, a cemented surface between the lens having the negative power and the resin adhesive layer and a cemented surface between the lens having the positive power and the resin adhesive layer have different aspherical shapes.

### SUMMARY

One embodiment according to the technology of the present disclosure provides a cemented lens including an aspherical lens and well-centered, and a manufacturing method of the cemented lens.

An aspect according to the technology of the present disclosure relates to a cemented lens in which a first cemented surface that is one lens surface of a first lens and a second cemented surface that is one lens surface of a second lens are cemented to each other by an adhesive, in which the second lens has an aspherical lens surface as the other lens surface, an aspherical axis of the aspherical lens surface of the second lens coincides with an optical axis of the first lens and is positionally deviated in a radial direction of the second lens with respect to a center of a paraxial spherical surface of the second cemented surface, and a thickness of the adhesive between the first cemented surface and the second cemented surface varies in a direction of the positional deviation.

In the technology of the present disclosure, the second cemented surface may have a spherical shape or an aspherical shape. In a case where the second cemented surface has a spherical shape, the “center of the paraxial spherical surface of the second cemented surface” is the same as the center of the spherical surface of the second cemented surface.

It is preferable that the first cemented surface and the second cemented surface have the same shape.

The first cemented surface, the other lens surface of the first lens, and the second cemented surface may be configured to have a spherical shape.

In a case where a refractive index of the second lens is denoted by Nglass and a refractive index of the adhesive is denoted by Nce, the cemented lens of the above-mentioned aspect preferably satisfies Conditional Expression (1), more preferably satisfies Conditional Expression (1-1), and still more preferably satisfies Conditional Expression (1-2).

$$0.8 \times Nglass < Nce < 1.2 \times Nglass \qquad ( 1 )$$

$$0.9 \times Nglass < Nce < 1.1 \times Nglass \qquad ( 1 - 1 )$$

$$0.95 \times Nglass < Nce < 1.05 \times Nglass \qquad ( 1 - 2 )$$

In the cemented lens of the above aspect, in a plane perpendicular to the optical axis, in a case where a position where the thickness of the adhesive in a direction of the above-mentioned optical axis is maximized is defined as a first position, a position where the first position is rotated by 90 degrees about the above-mentioned optical axis is defined as a second position, a position where the first position is rotated by 180 degrees about the above-mentioned optical axis is defined as a third position, and a position where the first position is rotated by 270 degrees about the above-mentioned optical axis is defined as a fourth position, an average value of thicknesses of the adhesive in the direction of the above-mentioned optical axis at a position of the above-mentioned optical axis, the first position, the second position, the third position, and the fourth position is preferably 10 μm or more and 50 μm or less, and more preferably 15 μm or more and 40 μm or less.

Another aspect according to the technology of the present disclosure is a manufacturing method of a cemented lens in which a first lens having a first cemented surface that is one lens surface and a second lens having a second cemented surface that is one lens surface and having an aspherical lens surface as the other lens surface are cemented to each other by an adhesive, the manufacturing method comprises a step of filling a space between the first cemented surface and the second cemented surface with the adhesive; a step of detecting an inclination angle of an aspherical axis of the aspherical lens surface with respect to an optical axis of the first lens and a positional deviation amount of the aspherical axis with respect to the above-mentioned optical axis in the aspherical lens surface in a radial direction of the first lens; a step of adjusting a relative position between the first lens and the second lens in accordance with the inclination angle and the positional deviation amount; and a step of curing the adhesive in a state where the relative position is adjusted.

It is preferable that the manufacturing method of a cemented lens according to the above-described aspect further comprises a step of making the above-mentioned optical axis coincide with the aspherical axis by relatively moving the first lens and the second lens in the radial direction of the first lens.

In the manufacturing method of a cemented lens according to the above-described aspect, it is preferable that a wavefront measurement of the first lens and the second lens is performed, a tilt component and a coma component are acquired from an interference fringe image obtained by the wavefront measurement, and the detection is performed based on the tilt component and the coma component.

According to the present disclosure, it is possible to provide a cemented lens including an aspherical lens and well-centered, and a manufacturing method of the cemented lens.

### BRIEF DESCRIPTION OF THE DRAWINGS

FIG. 1 is a cross-sectional view for describing a configuration of a cemented lens according to an embodiment.

FIG. 2 is a cross-sectional view for describing a conventional example 1.

FIG. 3 is a cross-sectional view for describing a conventional example 2.

FIG. 4 is a diagram showing a position where a thickness of an adhesive is measured.

FIG. 5 is a flowchart according to an example of a manufacturing method.

FIGS. 6A to 6E are schematic views of a step according to an example of the manufacturing method.

FIG. 7 is a conceptual diagram showing detection of an aspherical axis inclination and an aspherical axis deviation from an interference fringe image.

FIG. 8 is a flowchart according to another example of the manufacturing method.

FIGS. 9A to 9E are schematic views of a step according to another example of the manufacturing method.

FIG. 10 is data showing an aspherical axis inclination angle and an aspherical axis deviation amount of the examples and comparative examples.

FIG. 11 is data showing resolutions of the examples and the comparative examples.

FIG. 12 is a cross-sectional view showing a configuration of an imaging lens system.

### DETAILED DESCRIPTION

Hereinafter, embodiments of the present disclosure will be described with reference to the accompanying drawings. In the drawings below referred to in the following description, shapes of the respective components and ratios thereof are depicted with appropriate changes for easy visibility, and thus they do not necessarily show the accurate shapes and ratios. In addition, in the following description, a unit of length of micrometers is described as “μm”, a unit of wavelength of nanometers is described as “nm”, and a unit of angle of minutes is described as “min”.

### Overview of Configuration of Cemented Lens

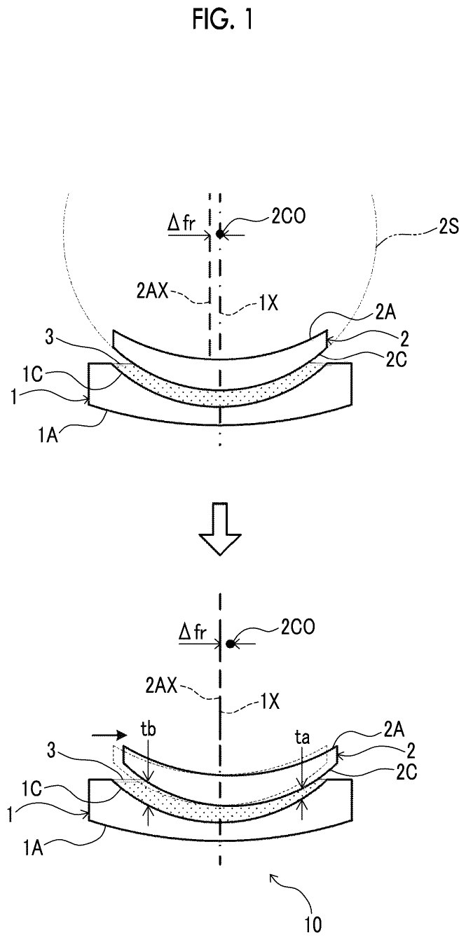

FIG. 1 is a cross-sectional view for describing a configuration of a cemented lens 10 according to an embodiment of the present disclosure. The cemented lens 10 is configured to include a first lens 1, a second lens 2, and an adhesive 3. A cemented lens 10 in a state before centering of the first lens 1 and the second lens 2 is shown on an upper side of FIG. 1, and a cemented lens 10 in a state after centering is shown on a lower side of FIG. 1. Here, for convenience of description, a lens set consisting of the first lens 1, the adhesive 3, and the second lens 2 before the adhesive 3 is cured is referred to as a cemented lens 10.

A first cemented surface 1C, which is one lens surface of the first lens 1, and a second cemented surface 2C, which is one lens surface of the second lens 2, are disposed to face each other. The first lens 1 and the second lens 2 are cemented to each other by the adhesive 3 filled between the first cemented surface 1C and the second cemented surface 2C. A first lens surface 1A, which is the other lens surface of the first lens 1, and a second lens surface 2A, which is the other lens surface of the second lens 2, are air contact surfaces that are not cemented in the example of FIG. 1.

In the example of FIG. 1, the second lens surface 2A has an aspherical shape, and the second cemented surface 2C, the first cemented surface 1C, and the first lens surface 1A have spherical shapes. In the present specification, a lens in which at least one of two lens surfaces has an aspherical shape is referred to as an “aspherical lens”, and a lens in which both of the two lens surfaces have a spherical shape is referred to as a “spherical lens”. Therefore, in the example of FIG. 1, the second lens 2 is an aspherical lens, and the first lens 1 is a spherical lens. In a case where the second cemented surface 2C, the first cemented surface 1C, and the first lens surface 1A have a spherical shape, the centering is easier than in a case where at least one of the second cemented surface 2C, the first cemented surface 1C, or the first lens surface 1A has an aspherical shape.

In the example of FIG. 1, the first cemented surface 1C and the second cemented surface 2C have the same shape. In the present specification, the same shape related to the lens surface means a shape formed based on the same design data. The term “same design data” means that the curvature radii are the same in a case of a spherical shape, means that the aspheric expressions and the aspherical coefficients are the same in a case of an aspherical shape, and means that the free curved surface expressions and the free curved surface coefficients are the same in a case of a free curved surface shape.

A center of the spherical surface, that is, a center of curvature is present in the spherical surface, whereas an aspherical axis is present in the aspherical surface. In the spherical lens, an axis passing through two points that are centers of spherical surfaces of two lens surfaces, that is, an axis passing through centers of curvature of two lens surfaces can be used as an optical axis of the lens. On the other hand, in the aspherical lens in which the two lens surfaces have an aspherical shape, since each of the two lens surfaces has aspherical axes, these two aspherical axes do not coincide with each other in the aspherical lens including a component error. In the case of an aspherical lens in which one of the two lens surfaces has a spherical shape and the other has an aspherical shape, similarly, in a case where the component error is included, the center of the spherical surface of the one lens surface is not positioned on the aspherical axis of the surface of the other lens. Therefore, in the aspherical lens including the component error, the axis is deviated between the two lens surfaces. It is difficult to make the component error of all the aspherical lenses zero in manufacturing.

The second lens 2 of the present example is a lens including the above-described component error. As shown in FIG. 1, the center 2CO of the spherical surface 2S of the second cemented surface 2C is not positioned on the aspherical axis 2AX of the second lens surface 2A, and a positional deviation of Δfr occurs in a radial direction of the second lens 2 with respect to the aspherical axis 2AX. In the following, in order to distinguish the positional deviation from other positional deviations, the positional deviation between the aspherical axis 2AX of the second lens 2 in the radial direction and the center 2CO of the spherical surface 2S of the cemented surface 2C is referred to as a “front and rear surface deviation Δfr”.

On the other hand, the optical axis 1X of the first lens 1 and the center 2CO of the spherical surface 2S of the second cemented surface 2C can be disposed to coincide with each other, and the upper side drawing of FIG. 1 shows a state in which the optical axis 1X and the center 2CO are disposed to coincide with each other. However, in the state shown in the upper side drawing of FIG. 1, the optical axis 1X of the first lens 1 and the aspherical axis 2AX of the second lens surface 2A do not coincide with each other, and are in a deviated state. In general, the influence on performance of the cemented lens 10 is greater in a state where the aspherical axis 2AX is deviated from the optical axis 1X of the first lens 1 than in a state where the aspherical axis 2AX is deviated from the center 2CO, and performance deterioration is greater.

Therefore, as indicated by the rightward arrow in the lower side drawing of FIG. 1, the second lens 2 is moved in the radial direction of the first lens 1 to perform centering such that the aspherical axis 2AX and the optical axis 1X of the first lens 1 coincide with each other. In the lower side drawing of FIG. 1, the second lens 2 before movement is shown by a broken line, and the second lens 2 after movement is shown by a solid line.

Due to the centering, a thickness of the adhesive 3 in an optical axis 1X direction before centering is almost uniform, whereas a thickness of the adhesive 3 in the optical axis 1X direction after centering varies in a direction of the front and rear surface deviation Δfr. In the lower side drawing of FIG. 1, a thickness tb of the adhesive 3 at a position on a left side of the aspherical axis 2AX is larger than a thickness ta of the adhesive 3 at a position on a right side of the aspherical axis 2AX. In this way, by providing a thickness distribution of the adhesive 3 in the direction of the front and rear surface deviation Δfr, the cemented lens 10 in which the optical axis 1X of the first lens 1 and the aspherical axis 2AX of the second lens 2 coincide with each other and are well centered can be obtained, and performance deterioration of the cemented lens 10 can be suppressed.

Next, in order to deepen the understanding of the technology of the present disclosure, a cemented lens using the related art will be described as a conventional example 1 and a conventional example 2.

### Conventional Example 1

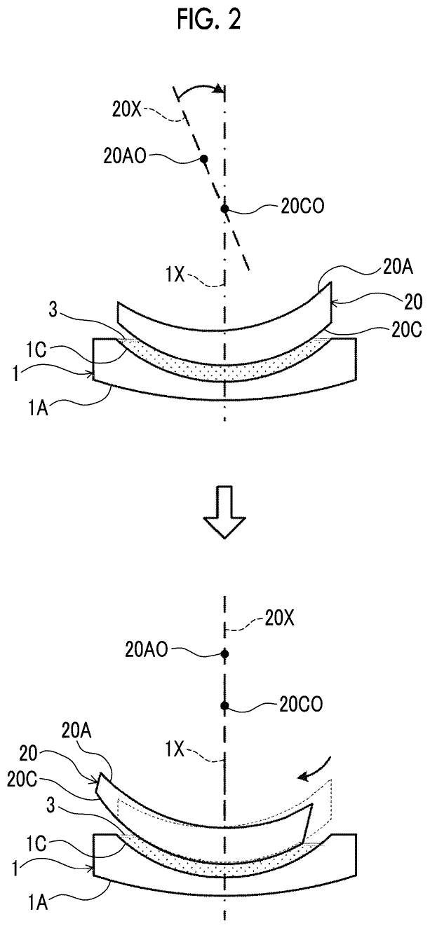

A description of a conventional example 1 will be made with reference to FIG. 2. Conventional example 1 is an example in which spherical lenses are cemented together. An upper side of FIG. 2 shows a state before centering, and a lower side shows a state after centering. The first lens 1 of FIG. 2 is the same as the first lens 1 of FIG. 1, but the second lens 20 of FIG. 2 is different from the second lens 2 of FIG. 1 in that the second lens 20 is a spherical lens.

A first cemented surface 1C, which is one lens surface of the first lens 1, and a second cemented surface 20C, which is one lens surface of the second lens 20, are disposed to face each other. The first lens 1 and the second lens 20 are cemented to each other by the adhesive 3 filled between the first cemented surface 1C and the second cemented surface 20C. A first lens surface 1A, which is the other lens surface of the first lens 1, and a second lens surface 20A, which is the other lens surface of the second lens 20, are air contact surfaces that are not cemented.

An axis passing through a center 20AO of the spherical surface of the second lens surface 20A and a center 20CO of the spherical surface of the second cemented surface 20C is an optical axis 20X of the second lens 20. In a state before centering shown in the upper side drawing of FIG. 2, the center 20CO of the spherical surface of the second cemented surface 20C is positioned on the optical axis 1X of the first lens 1, but the optical axis 20X of the second lens 20 is inclined with respect to the optical axis 1X of the first lens 1.

During centering, as indicated by an arrow in the lower side drawing of FIG. 2, the second lens 20 is swung along a curve having the same curvature as the second cemented surface 20C to coincide the optical axis 20X with the optical axis 1X of the first lens 1. In the lower side drawing of FIG. 2, the second lens 20 before swinging is shown by a broken line, and the second lens 20 after swinging is shown by a solid line.

In a normal centering method, the method starts from a state in which the adhesive 3 is filled between two cemented lenses to be cemented. The thickness of the adhesive 3 in this state is thin, for example, about 20 μm. In addition, in a state where the adhesive 3 is filled, a force of swinging the lens along the cemented surface is smaller than a force of moving the lens in the radial direction. From the above circumstances, in the conventional centering method of the cemented lenses of the spherical lenses, a method of swinging the lens along the cemented surface is often adopted. Hereinafter, the method of swinging the lens along the cemented surface to center the lens is referred to as “conventional centering method”.

### Conventional Example 2

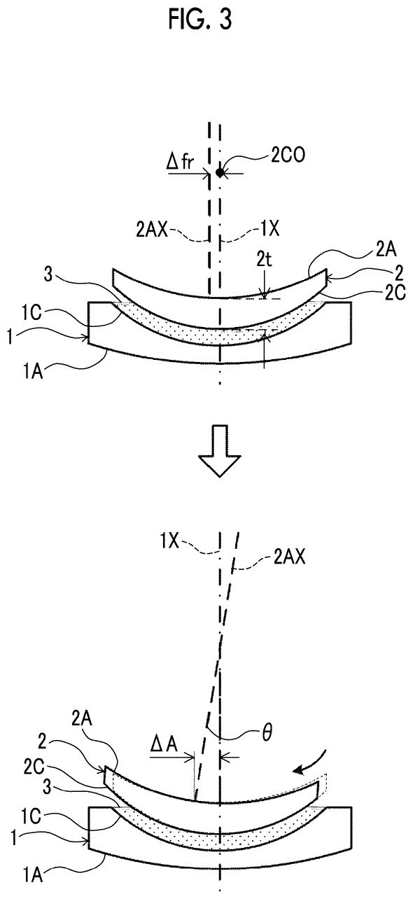

A description of a conventional example 2 will be made with reference to FIG. 3. Conventional example 2 is an example in which the above-described conventional centering method is applied to the cement of the spherical lens and the aspherical lens. An upper side of FIG. 3 shows a state before centering, and a lower side shows a state after centering. The first lens 1 and the second lens 2 of the conventional example 2 shown in FIG. 3 are the same as the first lens 1 and the second lens 2 of FIG. 1, respectively.

The state before centering shown in the upper side drawing of FIG. 3 is the same as the state before centering shown in the upper side drawing of FIG. 1. The second lens surface 2A has an aspherical axis 2AX in which a front and rear surface deviation Δfr occurs with respect to a center 2CO of a spherical surface (not shown in FIG. 3) of the second cemented surface 2C, and the optical axis 1X of the first lens 1 coincides with the center 2CO of the spherical surface of the second cemented surface 2C.

During the centering, as in the above-described conventional centering method, the second lens 2 is swung along a curve having the same curvature as the second cemented surface 2C as indicated by an arrow in the lower side drawing of FIG. 3. In the lower side drawing of FIG. 3, the second lens 2 before swinging is shown by a broken line, and the second lens 2 after swinging is shown by a solid line.

The aspherical axis 2AX after swinging does not coincide with the optical axis 1X of the first lens 1. After swinging, the aspherical axis 2AX is inclined by θ with respect to the optical axis 1X of the first lens 1, and a positional deviation of AA occurs on the second lens surface 2A. In the following, the inclination of the aspherical axis 2AX with respect to the optical axis 1X of the first lens 1 is referred to as an “aspherical axis inclination θ”, and the positional deviation of the aspherical axis 2AX with respect to the optical axis 1X of the first lens 1 on the second lens surface 2A in the radial direction of the first lens 1 is referred to as an “aspherical axis deviation ΔA”.

In a case where a paraxial curvature radius of the second lens surface 2A is denoted by R2A, a curvature radius of the second cemented surface 2C is denoted by R2C, and a central thickness of the second lens 2 is denoted by 2t, R2A, R2C, 2t, a front and rear surface deviation Δfr, an aspherical axis inclination θ, and an aspherical axis deviation ΔA are in a relationship represented by the following two expressions.

$$θ = Δ fr / ( R 2 A + 2 t - R 2 C )$$

$$Δ A = Δ fr \times R 2 A / ( R 2 A + 2 t - R 2 C )$$

As can be seen from the above two expressions, in the conventional centering method, the aspherical axis inclination θ and the aspherical axis deviation ΔA cannot be set to zero unless the front and rear surface deviation Δfr is set to zero. Further, from the above two expressions, the aspherical axis inclination θ and the aspherical axis deviation ΔA are in a relationship represented by the following expression. As shown in the following expression, in the conventional centering method, the aspherical axis inclination θ and the aspherical axis deviation ΔA are in a proportional relationship.

$$Δ A = R 2 A \times θ$$

As can be seen from the above, in the case of the cemented lens including the aspherical lens, in the conventional centering method, the influence on the front and rear surface deviation Δfr of the manufacturing error of the aspherical lens appears in the aspherical axis inclination θ and the aspherical axis deviation ΔA, and the influence cannot be removed. That is, in the conventional centering method, in the aspherical lens in which the front and rear surface deviation Δfr is present, the aspherical axis 2AX and the optical axis 1X of the first lens 1 cannot be made to coincide with each other. In the cemented lens in which the aspherical axis 2AX and the optical axis 1X of the first lens 1 do not coincide with each other, the optical performance is deteriorated. On the other hand, in the cemented lens according to the present disclosure in which the thickness of the adhesive 3 varies in the direction of the front and rear surface deviation Δfr as shown in FIG. 1, both the aspherical axis inclination θ and the aspherical axis deviation ΔA can be set to zero, and the aspherical axis 2AX and the optical axis 1X of the first lens 1 can be made to coincide with each other. Therefore, deterioration in optical performance can be suppressed, and it is possible to contribute to securing high optical performance.

### Preferred Configuration of Cemented Lens

Next, a preferred configuration of the cemented lens according to the present embodiment will be described. In the cemented lens 10 according to the present embodiment, since the adhesive 3 has a thickness distribution to reduce the influence of the front and rear surface deviation of the aspherical lens, it is preferable that a refractive index of the second lens 2 and a refractive index of the adhesive 3 are close to each other. Specifically, in a case where the refractive index of the second lens 2 is denoted by Nglass and the refractive index of the adhesive 3 is denoted by Nce, it is preferable that the cemented lens 10 satisfies Conditional Expression (1) below. By satisfying Conditional Expression (1), deterioration of the optical performance due to the adhesive 3 can be suppressed.

$$0.8 \times Nglass < Nce < 1.2 \times Nglass \qquad ( 1 )$$

In order to secure higher optical performance, it is more preferable that the cemented lens 10 satisfies Conditional Expression (1-1), and it is more preferable that the cemented lens 10 satisfies Conditional Expression (1-2).

$$0.9 \times Nglass < Nce < 1.1 \times Nglass \qquad ( 1 - 1 )$$

$$0.95 \times Nglass < Nce < 1.05 \times Nglass \qquad ( 1 - 2 )$$

Here, Nglass and Nce are refractive indices with respect to the d line. The wavelength of the d line is treated as 587.56 nm. The refractive index can be measured using, for example, a KALNUE precision refractometer KPR-3000 (manufactured by Shimadzu Corporation).

In order to provide a distribution in the thickness of the adhesive 3, an average value of the thickness of the adhesive 3 is preferably 10 μm or more. By setting the thickness to 10 μm or more, it is easy to provide a thickness distribution in the adhesive 3. Therefore, it is easy to center such that the aspherical axis 2AX and the optical axis 1X of the first lens 1 coincide with each other. More preferably, the average value of the thicknesses of the adhesive 3 is set to 15 μm or more. In addition, the average value of the thickness of the adhesive 3 is preferably 50 μm or less. By setting the thickness to 50 μm or less, a decrease in light transmittance and deterioration in optical performance due to the adhesive 3 can be suppressed. More preferably, the average value of the thicknesses of the adhesive 3 is set to 40 μm or less.

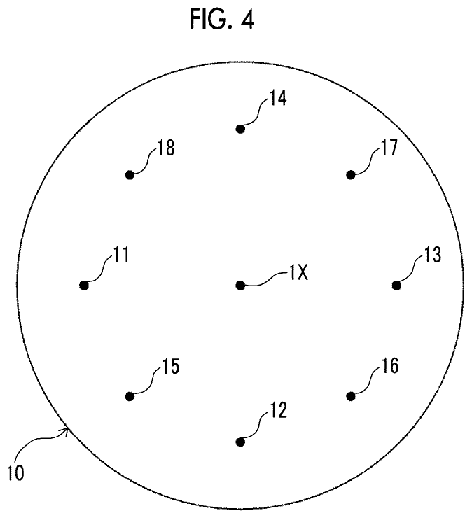

The average value of the thickness of the adhesive 3 will be described with reference to FIG. 4. FIG. 4 is a diagram of the cemented lens 10 in a plane perpendicular to the optical axis 1X as viewed from a first lens 1 side. As shown in FIG. 4, in the plane perpendicular to the optical axis 1X, a position where the thickness of the adhesive 3 in a direction of the optical axis 1X is maximized is defined as a first position 11, a position where the first position 11 is rotated by 90 degrees about the optical axis 1X is defined as a second position 12, a position where the first position 11 is rotated by 180 degrees about the optical axis 1X is defined as a third position 13, and a position where the first position 11 is rotated by 270 degrees about the optical axis 1X is defined as a fourth position 14. The thickness of the adhesive 3 in the direction of the optical axis 1X at five positions of the first position 11, the second position 12, the third position 13, the fourth position 14, and the position of the optical axis 1X is obtained, and an average value thereof is defined as the thickness of the adhesive 3.

In a case where a more detailed average value of the thickness is required, the thickness of the adhesive 3 in the direction of the optical axis 1X at a total of nine positions including the above-described five positions and the following a fifth position to an eighth position may be obtained, and the average value thereof may be used as the thickness of the adhesive 3. Here, as shown in FIG. 4, a position where the first position 11 is rotated by 45 degrees about the optical axis 1X is defined as a fifth position 15, a position where the first position 11 is rotated by 135 degrees about the optical axis 1X is defined as a sixth position 16, a position where the first position 11 is rotated by 225 degrees about the optical axis 1X is defined as a seventh position 17, and a position where the first position 11 is rotated by 315 degrees about the optical axis 1X is defined as an eighth position 18.

The position where the thickness of the adhesive 3 is maximized can be specified by, for example, a wavefront measurement device. As the wavefront measurement device, for example, a compact laser interferometer F601 (manufactured by FUJIFILM Corporation), a laser interferometer G102 (manufactured by FUJIFILM Corporation), and a laser interferometer Verifire (manufactured by Zygo Corporation) can be used. The thickness of the adhesive 3 can be measured, for example, by cutting the cemented lens 10 in a cross section including the direction of the optical axis 1X at each position and measuring the cross section with a scanning electron microscope (SEM).

### Manufacturing Method 1 for Cemented Lens

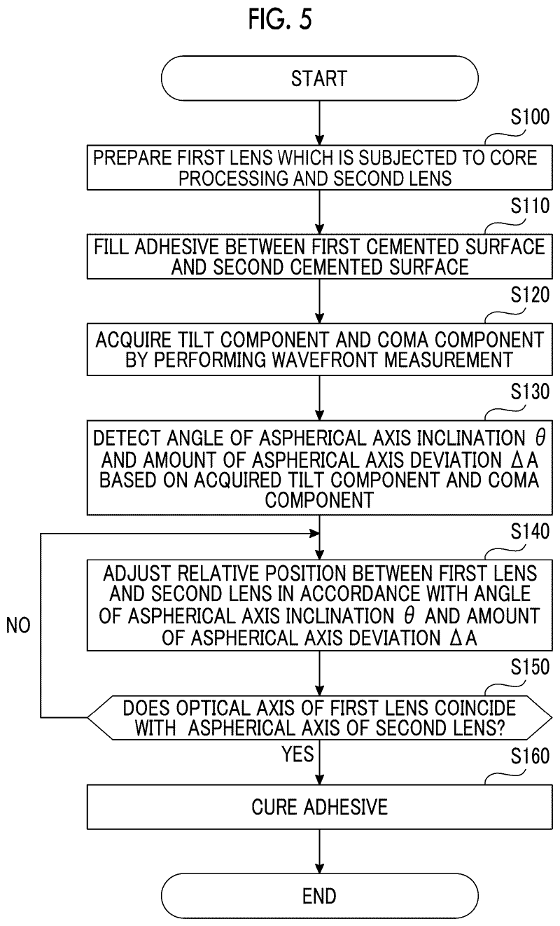

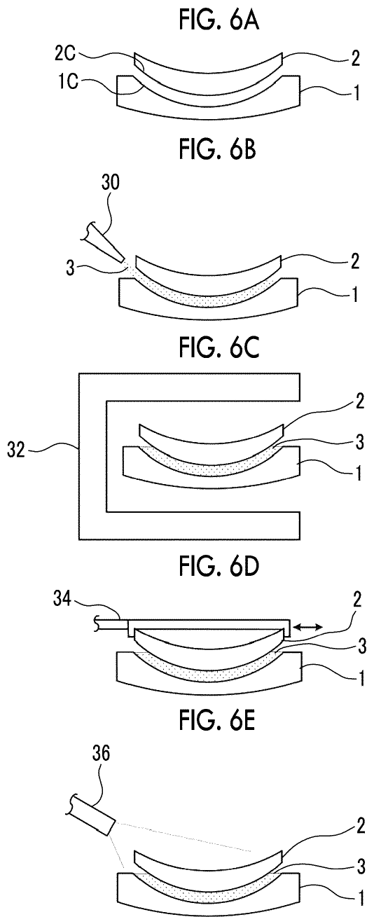

Next, an example of a method of manufacturing the cemented lens 10 of FIG. 1 will be described with reference to FIGS. 5 to 6E. FIG. 5 is a flowchart showing an operation procedure of the manufacturing method, and FIGS. 6A to 6E are views schematically showing steps of the manufacturing method. In the present example, the centering is performed after the adhesive 3 is filled.

In step S100 shown in FIG. 5, the first lens 1 which is subjected to core processing and the second lens 2 are prepared. Then, as shown in FIG. 6A, the first cemented surface 1C of the first lens 1 and the second cemented surface 2C of the second lens 2 are disposed to face each other. The core processing is processing of scraping an outer peripheral side surface of a lens such that a central axis of an outer diameter of the lens and an optical axis of the lens coincide with each other. That is, in the spherical lens subjected to the core processing, a central axis of an outer shape is the optical axis. The second lens 2 may or may not be subjected to core processing before cementing.

In step S110, as shown in FIG. 6B, the adhesive injector 30 fills the space between the first cemented surface 1C of the first lens 1 and the second cemented surface 2C of the second lens 2 with the adhesive 3. In the present example, as an example, an ultraviolet curable adhesive is used as the adhesive 3. As the adhesive 3, for example, various series of HARDLOC OP type (manufactured by Denka Company Limited) or WORLD ROCK (manufactured by Kyoritsu Chemical & Co., Ltd.) can be used.

In step S120, as shown in FIG. 6C, the wavefront measurement device 32 measures the wavefront of the entire lens set consisting of the first lens 1, the adhesive 3, and the second lens 2, and acquires a tilt component and a coma component from the interference fringe image obtained by the wavefront measurement. As the wavefront measurement device 32, for example, a compact laser interferometer F601 (manufactured by FUJIFILM Corporation), a laser interferometer G102 (manufactured by FUJIFILM Corporation), and a laser interferometer Verifire (manufactured by Zygo Corporation) can be used.

In step S130, an angle of the aspherical axis inclination θ and an amount of the aspherical axis deviation ΔA are detected based on the acquired tilt component and the acquired coma component.

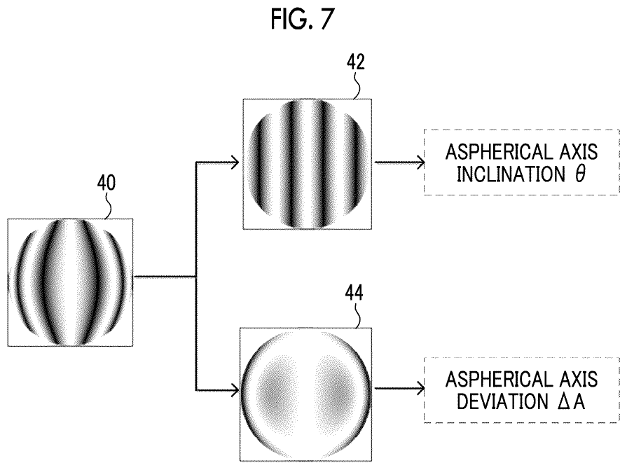

FIG. 7 is a conceptual diagram of the detection in step S120 and step S130. In the wavefront measurement, the interference fringe image 40 in a state where the tilt component and the coma component are mixed is obtained. Each component is separated using the wavefront measurement device 32 and a computer (not shown), and the tilt component 42 and the coma component 44 are acquired from the interference fringe image 40. The angle of the aspherical axis inclination θ can be detected from the tilt component 42, and the amount of the aspherical axis deviation ΔA can be detected from the coma component 44. As described above, by performing the wavefront measurement to acquire the tilt component 42 and the coma component 44 and using the tilt component 42 and the coma component 44, both the aspherical axis inclination θ and aspherical axis deviation ΔA can be detected with high accuracy at the same time. For example, a known technology disclosed in JP2008-249415A can be used for the operations of step S120 and step S130.

In step S140, a relative position between the first lens 1 and the second lens 2 is adjusted such that the optical axis 1X of the first lens 1 and the aspherical axis 2AX of the second lens 2 coincide with each other according to the detected angle of the aspherical axis inclination θ and the detected amount of the aspherical axis deviation ΔA. The adjustment is mainly performed by relatively moving the first lens 1 and the second lens 2 in a radial direction of the first lens 1. For example, as shown in FIG. 6D, the first lens 1 may be fixed, the second lens 2 may be gripped by the gripping member 34, and only the second lens 2 may be moved. Alternatively, the second lens 2 may be fixed and only the first lens 1 may be moved, or the first lens 1 and the second lens 2 may be moved. By relatively moving the first lens 1 and the second lens 2 in the radial direction of the first lens 1, both the aspherical axis inclination θ and the aspherical axis deviation ΔA can be easily adjusted, and it is easy for the optical axis 1X of the first lens 1 to coincide with the aspherical axis 2AX of the second lens 2. In addition, the adjustment may be performed by swinging at least one of the first lens 1 or the second lens 2 along a curve having the same curvature as the second cemented surface 20C, in addition to the movement in the radial direction.

In step S150, it is confirmed whether the optical axis 1X of the first lens 1 and the aspherical axis 2AX of the second lens 2 coincide with each other. Whether the optical axis 1X of the first lens 1 and the aspherical axis 2AX of the second lens 2 coincide with each other can be confirmed, for example, by performing wavefront measurement using the wavefront measurement device 32 used in step S120.

Alternatively, instead of the wavefront measurement, an ultra-high accuracy three-dimensional measuring machine UA3P (manufactured by Panasonic Production Engineering Co., Ltd.) may be used for the confirmation. In a case where the ultra-high accuracy three-dimensional measuring machine UA3P is used, the following is performed. A direction of the aspherical axis 2AX of the second lens surface 2A is defined as a z direction, and two directions orthogonal to the z direction are defined as an x direction and a y direction, respectively. The aspherical shape of the second lens surface 2A is measured to acquire a plurality of pieces of point cloud data. The point cloud data is acquired in the x direction and the y direction at, for example, a 10 μm pitch. The aspherical axis inclination θ and the aspherical axis deviation ΔA can be specified by performing fitting on the point cloud data using the following aspheric expression with coefficients of the aspheric expression as parameters. In the following aspheric expressions, a curvature is denoted by c, a conic coefficient is denoted by k, an aspherical coefficient is denoted by αi, and a distance from the aspherical axis 2AX to a measurement point is denoted by r.

$$z = \frac{{cr}^{2}}{1 + \sqrt{1 - ( 1 + k ) {c}^{2} {r}^{2}}} + {\sum }_{i = 1}^{N} {α}_{i} {r}^{i}$$

In a case where the optical axis 1X of the first lens 1 and the aspherical axis 2AX of the second lens 2 do not coincide with each other, the process returns to step S140, and the relative position between the first lens 1 and the second lens 2 is adjusted.

In a case where the optical axis 1X of the first lens 1 and the aspherical axis 2AX of the second lens 2 coincide with each other, in step S160, as shown in FIG. 6E, the adhesive 3 is cured by irradiating the adhesive 3 with ultraviolet rays from the ultraviolet ray irradiator 36 in a state where the relative position between the first lens 1 and the second lens 2 is adjusted. The expression “the adhesive 3 is cured in the adjusted state” includes both a case where the curing of the adhesive 3 is started after the adjustment is completely finished and a case where the adjustment is performed after the curing of the adhesive 3 is started until the curing is completely finished. That is, it is sufficient for the adjusted state to be achieved by the time at which curing is finished, and the adjustment may be finished or may not be finished at the time at which the curing is started.

### Manufacturing Method 2 for Cemented Lens

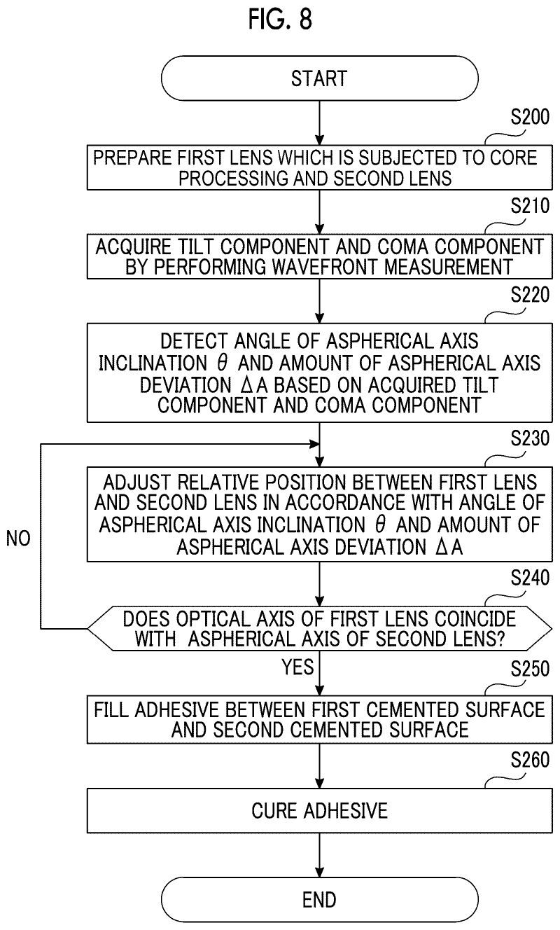

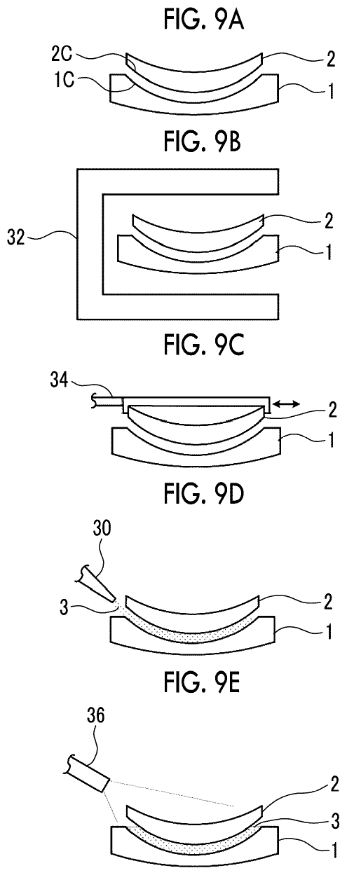

Next, another example of a method of manufacturing the cemented lens 10 of FIG. 1 will be described with reference to FIGS. 8 to 9E. FIG. 8 is a flowchart showing an operation procedure of the manufacturing method, and FIGS. 9A to 9E are views schematically showing steps of the manufacturing method. The manufacturing method 2 is significantly different from the manufacturing method 1 in that the adhesive 3 is filled after the centering, and basically, the procedure is different. Therefore, in the following description of the manufacturing method 2, the same reference numerals are assigned to the same devices, members, and the like as those in the manufacturing method 1, and the duplicate description thereof will be omitted, and mainly the difference from the manufacturing method 1 will be described.

In step S200 shown in FIG. 8, the first lens 1 which is subjected to core processing and the second lens 2 are prepared. Then, as shown in FIG. 9A, the first cemented surface 1C of the first lens 1 and the second cemented surface 2C of the second lens 2 are disposed to face each other.

In step S210, as shown in FIG. 9B, the wavefront measurement device 32 measures the wavefront of the entire lens set consisting of the first lens 1 and the second lens 2, and acquires a tilt component and a coma component from the interference fringe image obtained by the wavefront measurement.

In step S220, an angle of the aspherical axis inclination θ and an amount of the aspherical axis deviation ΔA are detected based on the acquired tilt component and the acquired coma component.

In step S230, a relative position between the first lens 1 and the second lens 2 is adjusted such that the optical axis 1X of the first lens 1 and the aspherical axis 2AX of the second lens 2 coincide with each other according to the detected angle of the aspherical axis inclination θ and the detected amount of the aspherical axis deviation ΔA. For example, as shown in FIG. 9C, the first lens 1 may be fixed, the second lens 2 may be gripped by the gripping member 34, and only the second lens 2 may be moved.

In step S240, it is confirmed whether the optical axis 1X of the first lens 1 and the aspherical axis 2AX of the second lens 2 coincide with each other. In a case where the optical axis 1X of the first lens 1 and the aspherical axis 2AX of the second lens 2 do not coincide with each other, the process returns to step S230, and the relative position between the first lens 1 and the second lens 2 is adjusted.

In a case where the optical axis 1X of the first lens 1 and the aspherical axis 2AX of the second lens 2 coincide with each other, in step S250, as shown in FIG. 9D, the adhesive 3 is filled between the first cemented surface 1C of the first lens 1 and the second cemented surface 2C of the second lens 2 from the adhesive injector 30 in a state where the relative position between the first lens 1 and the second lens 2 is adjusted.

In step S260, the adhesive 3 is cured by irradiating the adhesive 3 with ultraviolet rays from the ultraviolet ray irradiator 36 in a state where the relative position between the first lens 1 and the second lens 2 is adjusted.

### Comparison Between Examples and Comparative Examples

Next, the comparative data between Examples and Comparative Examples will be described. Examples described below are cemented lenses manufactured by using the manufacturing method of the present disclosure or cemented lenses assumed to be manufactured using the manufacturing method of the present disclosure. The comparative examples described below are cemented lenses manufactured using a conventional centering method or cemented lenses assumed to be manufactured using a conventional centering method. The design data (that is, the shape, refractive index, and Abbe number of each lens) of Examples and Comparative Examples described below are the same, and the adhesives used for cementing are also the same.

### Comparative Data 1

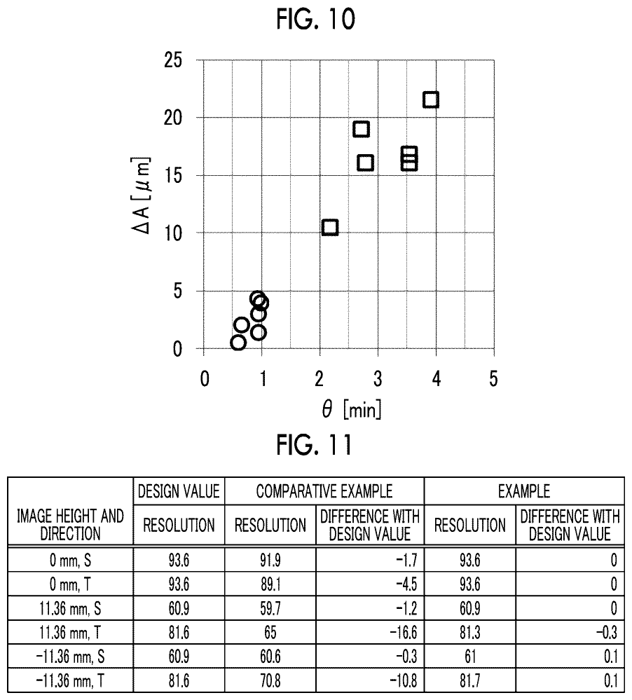

FIG. 10 is a diagram showing the aspherical axis inclination θ and the aspherical axis deviation ΔA in the actually manufactured example and the actually manufactured comparative example. In FIG. 10, a lateral axis represents the aspherical axis inclination θ, and a vertical axis represents the aspherical axis deviation ΔA. In FIG. 10, examples are plotted with a symbol of “O”, and comparative examples are plotted with a symbol of “□”.

As shown in FIG. 10, both the aspherical axis inclination θ and the aspherical axis deviation ΔA of the comparative example have large values and large variations. In comparison, both the aspherical axis inclination θ and the aspherical axis deviation ΔA of the examples have very small values and small variations.

### Comparative Data 2

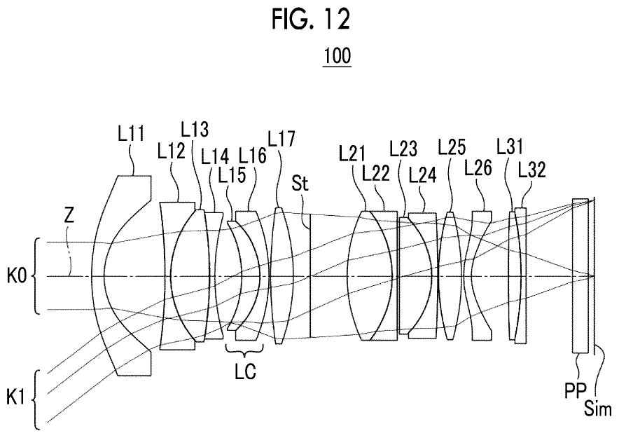

FIG. 11 is data showing a resolution in a case where the example or the comparative example is applied to a part of the imaging lens system 100 shown in FIG. 12. The resolution in FIG. 11 is a value of a modulation transfer function (MTF) obtained by optical simulation. Here, a cemented lens that is assumed to be manufactured using the manufacturing method according to the present disclosure is used as an example, and a cemented lens that is assumed to be manufactured using the conventional centering method is used as a comparative example.

The imaging lens system 100 can be used, for example, as an imaging lens for a digital camera application. FIG. 12 shows a cross-sectional view of a configuration of the imaging lens system 100. In FIG. 12, a left side is an object side, and a right side is an image side. The imaging lens system 100 consists of lenses L11 to L17, an aperture stop St, lenses L21 to L26, and lenses L31 and L32 in order from the object side to the image side along an optical axis Z. Among these, the cemented lens LC in which the lens L15 and the lens L16 are cemented is an example or a comparative example. The cemented lens LC includes an adhesive between the lens L15 and the lens L16. In FIG. 12, a filter PP, an on-axis luminous flux K0, and a luminous flux K1 with the maximum angle of view, which are disposed between the imaging lens system 100 and the image plane Sim, are also shown. Detailed data of the imaging lens system 100 will be described below.

The resolution shown in FIG. 11 is a value of the MTF at a wavelength of 587.56 nm and a frequency of 45 lines pair per millimeter (lp/mm) at the focusing position where the image height is θ. The column of “image height and direction” in FIG. 11 shows the image height and the direction from the optical axis Z. “S” indicates a sagittal direction, and “T” indicates a tangential direction. The values of the front and rear surface deviation Δfr, the aspherical axis inclination θ, and the aspherical axis deviation ΔA used in the optical simulation are Δfr=10 μm, θ=3.5 min, and ΔA=21 μm for the comparative examples, and Δfr=10 μm, θ=0 min, and ΔA=0 μm for the examples, respectively.

As shown in FIG. 11, the resolution of the comparative example is lower than the design value, and the performance is deteriorated. On the other hand, it can be seen that the performance deterioration can be satisfactorily suppressed since the difference between the resolution of the example and the design value is zero or almost zero.

The detailed data of the imaging lens system 100 will be shown below. Table 1 shows basic lens data, Table 2 shows specifications and variable surface spacing, and Table 3 shows aspherical coefficients. Tables 1 to 3 show numerical values rounded to predetermined decimal places.

In Table 1, the column of “Surface number” shows surface numbers in a case where a surface closest to the object side is the first surface and the surface numbers are increased one by one toward the image side, the column of “Curvature radius” shows a curvature radius of each surface, the column of “Surface spacing” shows a surface spacing on the optical axis between each surface and the surface adjacent to the image side, the column of “Refractive index” shows a refractive index of each constituent element with respect to the d line, and the column of “Abbe number” shows an Abbe number of each constituent element with reference to the d line. The seventh surface to the tenth surface of Table 1 are cemented lenses LC consisting of the lens L15, an adhesive, and the lens L16. In the columns of “Refractive index” and “Abbe number” on the eighth surface, the refractive index and the Abbe number of the adhesive are shown, respectively. The imaging lens system 100 includes a cemented lens in addition to the cemented lens LC, but data of an adhesive is not input for the other cemented lenses.

In Table 1, a reference numeral of a curvature radius of a surface facing the object side with a convex shape is positive, and a reference numeral of a curvature radius of a surface facing the image side with a convex shape is negative. Table 1 also shows the aperture stop St and the filter PP. In a column of a surface number of a surface corresponding to the aperture stop St, the surface number and a term of (St) are noted. The value in the lowest column of “Surface spacing” in Table 1 is a spacing between the surface closest to the image side and the image plane Sim in the table.

Table 2 shows each value of the focal length, the open F number, the maximum total angle of view 2ω, and the maximum image height. [°] in the column of the maximum total angle of view indicates that the unit is degrees. Table 2 shows values in a case where the d line is used as a reference in a state where the infinite distance object is in focus. In a case where the imaging lens system 100 focuses on the short distance object from the infinite distance object, the lenses L21 to L26 are integrally moved to the object side to perform focusing. The term “integrally moved” means moving by the same amount and in the same direction at the same time.

In Table 1, the surface number of the aspherical surface is marked with *, and the numerical value of the paraxial curvature radius is described in the column of the curvature radius of the aspherical surface. In Table 3, the surface number columns show the surface numbers of the aspherical surfaces, and KA and Am (m=3, 4, 5, . . . , 16) columns show numerical values of aspherical coefficients for each aspherical surface. The “E±n” (n: an integer) in numerical values of the aspherical coefficients of Table 3 indicates “×10^{±n}”. Note that KA and Am are the aspherical coefficients in an aspheric equation represented by the following equation.

$$Z d = C \times {h}^{2} / \{ 1 + {( 1 - KA \times {C}^{2} \times {h}^{2} )}^{1 / 2} \} + \sum Am \times {h}^{m}$$

### Here,

Zd is the aspherical depth (length of a perpendicular line drawn from a point on the aspherical surface at height h to a plane perpendicular to the optical axis Z in contact which the aspherical apex),
h is the height (distance from the optical axis Z to the lens surface),
C is the paraxial curvature,
KA and Am are aspherical coefficients, and
Σ in the aspheric equation means the sum of m.

TABLE 1

| Surface | Curvature | Surface | Refractive | Abbe |
|---|---|---|---|---|
| number | radius | spacing | index | number |
| *1 | 42.5066 | 2.2600 | 1.58313 | 59.46 |
| *2 | 14.3565 | 11.0287 | | |
| 3 | −100.1648 | 1.0200 | 1.58313 | 59.46 |
| 4 | 18.6299 | 7.0500 | 1.89190 | 37.13 |
| 5 | −75.4980 | 0.9700 | 1.48749 | 70.42 |
| 6 | 42.5062 | 4.8671 | | |
| *7 | −20.6733 | 3.2800 | 1.58313 | 59.46 |
| 8 | −13.9817 | 0.02 | 1.556 | 42.8 |
| 9 | −13.9817 | 1.6600 | 2.00069 | 25.43 |
| 10 | −31.4975 | 0.3000 | | |
| 11 | 89.0372 | 4.1100 | 1.95375 | 32.32 |
| 12 | −38.4770 | 3.1390 | | |
| 13(St) | ∞ | 6.5800 | | |
| 14 | 28.6629 | 8.1800 | 1.59282 | 68.62 |
| 15 | −19.7999 | 0.9100 | 1.85451 | 25.15 |
| 16 | ∞ | 0.4007 | | |
| 17 | ∞ | 5.8500 | 1.77250 | 49.61 |
| 18 | −15.4540 | 1.0900 | 1.85451 | 25.15 |
| 19 | −209.9846 | 0.1389 | | |
| 20 | 45.3596 | 4.1600 | 2.00272 | 19.32 |
| 21 | −45.3596 | 0.4000 | | |
| *22 | 16.1711 | 1.3856 | 1.80610 | 40.73 |
| *23 | 11.0173 | 6.7200 | | |
| 24 | 363.2443 | 2.2800 | 1.60300 | 65.46 |
| 25 | −62.1067 | 0.9200 | 1.84667 | 23.79 |
| 26 | ∞ | 8.4141 | | |
| 27 | ∞ | 2.8500 | 1.51680 | 64.20 |
| 28 | ∞ | 1.1000 | | |

TABLE 2

| | |
|---|---|
| Focal length | 17.90 |
| Open F number | 1.44 |
| Maximum total | 78.6 |
| angle of view [°] | |
| Maximum image | 14.2 |
| height | |

TABLE 3

| Surface number | 1 | 2 | 7 |
|---|---|---|---|
| KA | 3.8510739E+00 | −4.3296751E+00 | −3.0025899E+00 |
| A3 | 0.0000000E+00 | 0.0000000E+00 | 0.0000000E+00 |
| A4 | 8.2101298E−05 | 3.1069943E−04 | −5.9789840E−05 |
| A5 | −9.5739997E−06 | −1.0193003E−05 | 4.0272162E−07 |
| A6 | 5.9588626E−07 | −9.9029127E−07 | −1.2393722E−06 |
| A7 | −3.0455959E−08 | 7.4165898E−09 | 3.9428093E−07 |
| A8 | −1.9480492E−09 | 5.8171636E−09 | −3.5102283E−08 |
| A9 | 4.0864450E−10 | 1.7037688E−10 | −2.4364513E−09 |
| A10 | −1.4919699E−11 | −1.6321215E−11 | 3.7344047E−10 |
| A11 | −1.8257720E−13 | −1.4903567E−12 | 3.9820245E−11 |
| A12 | −2.7147724E−14 | −2.8746210E−13 | −6.3260902E−12 |
| A13 | 3.4618551E−15 | 5.1753338E−14 | −2.0073400E−13 |
| A14 | −2.7227826E−18 | −2.5285882E−15 | 7.3073525E−14 |
| A15 | −6.6705344E−18 | 4.0808858E−17 | −4.4848603E−15 |
| A16 | 1.4994304E−19 | −8.7993111E−21 | 9.4036412E−17 |

| Surface number | 21 | 22 |
|---|---|---|
| KA | −5.0000027E+00 | −1.4211109E+00 |
| A3 | 0.0000000E+00 | 0.0000000E+00 |
| A4 | −1.5689881E−05 | 3.0065970E−05 |
| A5 | −6.5802732E−06 | −1.9431301E−05 |
| A6 | −6.9255100E−07 | 3.3138973E−06 |
| A7 | 1.4479909E−08 | −4.3716353E−07 |
| A8 | 1.4122715E−08 | 2.8105186E−08 |
| A9 | −3.4964926E−10 | 1.7441042E−09 |
| A10 | −7.5590845E−11 | −1.5417488E−10 |
| A11 | 6.1173246E−12 | −2.3068826E−11 |
| A12 | −9.6603698E−13 | 1.2815061E−12 |
| A13 | 7.7251258E−14 | 2.3110962E−13 |
| A14 | 1.1107596E−15 | −2.7371328E−14 |
| A15 | −3.0214962E−16 | 1.2010839E−15 |
| A16 | 7.8465436E−18 | −2.1499728E−17 |

### Various Modification Examples

In the above-described embodiment, the example in which the second cemented surface 2C has a spherical shape has been described, but the second cemented surface 2C may have an aspherical shape. In a case where the second cemented surface 2C has an aspherical shape, the above-described “center 2CO of the spherical surface of the second cemented surface 2C” can be similarly considered by replacing the center 2CO with the center of the paraxial spherical surface of the second cemented surface 2C.

In the above-described embodiment, the example in which the first cemented surface 1C and the first lens surface 1A have a spherical shape has been described, but at least one of the first cemented surface 1C or the first lens surface 1A may have an aspherical shape. In a case where only one of the two lens surfaces of the first lens 1 has an aspherical shape, the “optical axis 1X of the first lens 1” is an aspherical axis of the aspherical shape. In addition, in a case where both of the two lens surfaces of the first lens 1 have an aspherical shape, the “optical axis 1X of the first lens 1” is an aspherical axis of the lens surface that is an air contact surface.

In the above-described embodiment, an example in which the first cemented surface 1C and the second cemented surface 2C have the same shape has been described, but the first cemented surface 1C and the second cemented surface 2C may have different shapes. However, it is preferable that the first cemented surface 1C and the second cemented surface 2C have the same shape. By making these two cemented surfaces have the same shape, a flow of the adhesive is likely to be smooth in a case of centering the aspherical axis 2AX and the optical axis 1X. In a case where the two cemented surfaces have a different shape, a width of a flow path of the adhesive may be increased or decreased, and in this case, there is a concern that the flow of the adhesive may be hindered.

In the above-described embodiment, the example of two cemented lenses is shown as the cemented lens, but a cemented lens in which three or more lenses such as a cemented lens of three lenses are cemented may be used. That is, at least one of the first lens surface 1A or the second lens surface 2A may be a cemented surface that is cemented to another lens.

In the above-described embodiment, the cemented lens of the negative lens and the positive lens has been shown and described, but the reference numeral of a optical power of the cemented lens is not limited thereto. In addition, the uneven shape of each lens surface is not limited to the example shown in the drawing and can be optionally selected.

In the present specification, the term “coincide” related to the axis refers to a coincidence in the sense of including an error generally allowed in the technical field of the present disclosure, in addition to a perfect coincidence. In the present specification, the term “same” refers to being the same in a sense including an error generally allowed in the technical field of the present disclosure, in addition to being completely the same. In the present specification, the term “zero” refers to being zero in a sense including an error generally allowed in the technical field of the present disclosure, in addition to being completely zero. In the present specification, the term “maximum” refers to being maximum in a sense including an error generally allowed in the technical field of the present disclosure, in addition to being completely maximum. In the present specification, the term “center” refers to a center in a sense including an error generally allowed in the technical field of the present disclosure, in addition to a perfect center. In the present specification, the term “average” refers to an average in the sense of including an error generally allowed in the technical field of the present disclosure, in addition to a perfect average. In the present specification, “90 degrees” refers to 90 degrees in the sense of including an error generally allowed in the technical field of the present disclosure, in addition to the exact 90 degrees. The same applies to “180 degrees”, “270 degrees”, “45 degrees”, “135 degrees”, “225 degrees”, and “315 degrees” in the present specification.

The above-described contents and illustrated contents are detailed descriptions of parts related to the technology of the present disclosure, and are merely examples of the technology of the present disclosure. For example, the descriptions related to the configuration, the function, the operation, and the effect are descriptions related to examples of a configuration, a function, an operation, and an effect of a part according to the technique of the present disclosure. Therefore, it goes without saying that, in the described contents and illustrated contents, unnecessary parts may be deleted, new components may be added, or replacements may be made without departing from the spirit of the technique of the present disclosure. In order to avoid complication and easily understand the parts according to the technology of the present disclosure, in the above-described contents and illustrated contents, common technical knowledge and the like that do not need to be described to implement the technology of the present disclosure are not described.

All documents, patent applications, and technical standards described in the present specification are incorporated in the present specification by reference to the same extent as in a case where each document, patent application, and technical standard are specifically and individually noted to be incorporated by reference.

The following technologies can be ascertained by the above description.

### [Supplementary Claim 1]

A cemented lens in which a first cemented surface that is one lens surface of a first lens and a second cemented surface that is one lens surface of a second lens are cemented to each other by an adhesive, in which the second lens has an aspherical lens surface as the other lens surface, an aspherical axis of the aspherical lens surface of the second lens coincides with an optical axis of the first lens and is positionally deviated in a radial direction of the second lens with respect to a center of a paraxial spherical surface of the second cemented surface, and a thickness of the adhesive between the first cemented surface and the second cemented surface varies in a direction of the positional deviation.

### [Supplementary Claim 2]

The cemented lens according to supplementary claim 1, in which the first cemented surface and the second cemented surface have the same shape.

### [Supplementary Claim 3]

The cemented lens according to supplementary claim 1 or supplementary claim 2, in which the first cemented surface, the other lens surface of the first lens, and the second cemented surface have a spherical shape.

### [Supplementary Claim 4]

The cemented lens according to any one of supplementary claim 1 to supplementary claim 3,
in which in a case where a refractive index of the second lens is defined as Nglass, and a refractive index of the adhesive is defined as Nce, Conditional expression (1) is satisfied, which is represented by

$$0.8 \times Nglass < Nce < 1.2 \times Nglass . \qquad ( 1 )$$

### [Supplementary Claim 5]

The cemented lens according to supplementary claim 4, in which Conditional Expression (1-1) is satisfied, which is represented by

$$0.9 \times Nglass < Nce < 1.1 \times Nglass . \qquad ( 1 - 1 )$$

### [Supplementary Claim 6]

The cemented lens according to supplementary claim 4, in which Conditional Expression (1-2) is satisfied, which is represented by

$$0.95 \times Nglass < Nce < 1.05 \times Nglass . \qquad ( 1 - 2 )$$

### [Supplementary Claim 7]

The cemented lens according to any one of supplementary claim 1 to supplementary claim 6,
in which in a plane perpendicular to the optical axis, in a case where a position where the thickness of the adhesive in a direction of the optical axis is maximized is defined as a first position, a position where the first position is rotated by 90 degrees about the optical axis is defined as a second position, a position where the first position is rotated by 180 degrees about the optical axis is defined as a third position, and a position where the first position is rotated by 270 degrees about the optical axis is defined as a fourth position,
an average value of thicknesses of the adhesive in the direction of the optical axis at a position of the optical axis, the first position, the second position, the third position, and the fourth position is 10 μm or more and 50 μm or less.

### [Supplementary Claim 8]

The cemented lens according to supplementary claim 7, in which the average value of the thicknesses is 15 μm or more and 40 μm or less.

### [Supplementary Claim 9]

A manufacturing method of a cemented lens in which a first lens having a first cemented surface that is one lens surface and a second lens having a second cemented surface that is one lens surface and having an aspherical lens surface as the other lens surface are cemented to each other by an adhesive, the manufacturing method comprising:
a step of filling a space between the first cemented surface and the second cemented surface with the adhesive;
a step of detecting an inclination angle of an aspherical axis of the aspherical lens surface with respect to an optical axis of the first lens and a positional deviation amount of the aspherical axis with respect to the optical axis in the aspherical lens surface in a radial direction of the first lens;
a step of adjusting a relative position between the first lens and the second lens in accordance with the inclination angle and the positional deviation amount; and
a step of curing the adhesive in a state where the relative position is adjusted.

### [Supplementary Claim 10]

The manufacturing method of a cemented lens according to supplementary claim 9, further comprising:
a step of making the optical axis coincide with the aspherical axis by relatively moving the first lens and the second lens in the radial direction of the first lens.

### [Supplementary Claim 11]

The manufacturing method of a cemented lens according to supplementary claim 9 or supplementary claim 10,
in which a wavefront measurement of the first lens and the second lens is performed, a tilt component and a coma component are acquired from an interference fringe image obtained by the wavefront measurement, and the detection is performed based on the tilt component and the coma component.

What is claimed is:

1. A cemented lens in which a first cemented surface that is one lens surface of a first lens and a second cemented surface that is one lens surface of a second lens are cemented to each other by an adhesive,
wherein the second lens has an aspherical lens surface as the other lens surface,
an aspherical axis of the aspherical lens surface of the second lens coincides with an optical axis of the first lens and is positionally deviated in a radial direction of the second lens with respect to a center of a paraxial spherical surface of the second cemented surface, and
a thickness of the adhesive between the first cemented surface and the second cemented surface varies in a direction of the positional deviation.

2. The cemented lens according to claim 1,
wherein the first cemented surface and the second cemented surface have the same shape.

3. The cemented lens according to claim 1,
wherein the first cemented surface, the other lens surface of the first lens, and the second cemented surface have a spherical shape.

4. The cemented lens according to claim 1,
wherein in a case where a refractive index of the second lens is denoted by Nglass, and a refractive index of the adhesive is denoted by Nce, Conditional expression (1) is satisfied, which is represented by
$$0.8 \times Nglass < Nce < 1.2 \times Nglass . \qquad ( 1 )$$

5. The cemented lens according to claim 4,
wherein Conditional Expression (1-1) is satisfied, which is represented by
$$0.9 \times Nglass < Nce < 1.1 \times Nglass . \qquad ( 1 - 1 )$$

6. The cemented lens according to claim 4,
wherein Conditional Expression (1-2) is satisfied, which is represented by
$$0.95 \times Nglass < Nce < 1.05 \times Nglass . \qquad ( 1 - 2 )$$

7. The cemented lens according to claim 1,
wherein in a plane perpendicular to the optical axis, in a case where a position where the thickness of the adhesive in a direction of the optical axis is maximized is defined as a first position, a position where the first position is rotated by 90 degrees about the optical axis is defined as a second position, a position where the first position is rotated by 180 degrees about the optical axis is defined as a third position, and a position where the first position is rotated by 270 degrees about the optical axis is defined as a fourth position,
an average value of thicknesses of the adhesive in the direction of the optical axis at a position of the optical axis, the first position, the second position, the third position, and the fourth position is 10 μm or more and 50 μm or less.

8. The cemented lens according to claim 7,
wherein the average value of the thicknesses is 15 μm or more and 40 μm or less.

9. A manufacturing method of a cemented lens in which a first lens having a first cemented surface that is one lens surface and a second lens having a second cemented surface that is one lens surface and having an aspherical lens surface as the other lens surface are cemented to each other by an adhesive, the manufacturing method comprising:
a step of filling a space between the first cemented surface and the second cemented surface with the adhesive;
a step of detecting an inclination angle of an aspherical axis of the aspherical lens surface with respect to an optical axis of the first lens and a positional deviation amount of the aspherical axis with respect to the optical axis in the aspherical lens surface in a radial direction of the first lens;
a step of adjusting a relative position between the first lens and the second lens in accordance with the inclination angle and the positional deviation amount; and
a step of curing the adhesive in a state where the relative position is adjusted.

10. The manufacturing method of a cemented lens according to claim 9, further comprising:
a step of making the optical axis coincide with the aspherical axis by relatively moving the first lens and the second lens in the radial direction of the first lens.

11. The manufacturing method of a cemented lens according to claim 9,
wherein a wavefront measurement of the first lens and the second lens is performed, a tilt component and a coma component are acquired from an interference fringe image obtained by the wavefront measurement, and the detection is performed based on the tilt component and the coma component.

12. The manufacturing method of a cemented lens according to claim 9,
wherein the first cemented surface and the second cemented surface have the same shape.

13. The manufacturing method of a cemented lens according to claim 9,
wherein the first cemented surface, the other lens surface of the first lens, and the second cemented surface have a spherical shape.

14. The manufacturing method of a cemented lens according to claim 9,
wherein in a case where a refractive index of the second lens is denoted by Nglass, and a refractive index of the adhesive is denoted by Nce, Conditional expression (1) is satisfied, which is represented by
$$0.8 \times Nglass < Nce < 1.2 \times Nglass . \qquad ( 1 )$$

15. The manufacturing method of a cemented lens according to claim 9,
wherein in a plane perpendicular to the optical axis, in a case where a position where the thickness of the adhesive in a direction of the optical axis is maximized is defined as a first position, a position where the first position is rotated by 90 degrees about the optical axis is defined as a second position, a position where the first position is rotated by 180 degrees about the optical axis is defined as a third position, and a position where the first position is rotated by 270 degrees about the optical axis is defined as a fourth position,
an average value of thicknesses of the adhesive in the direction of the optical axis at a position of the optical axis, the first position, the second position, the third position, and the fourth position is 10 μm or more and 50 μm or less.
